(19) United States
(12) Patent Application Publication
(10) Pub. No.: US 2009/0217765 A1
(43) Pub. Date: Sep. 3, 2009

(54) SENSOR FAILURE DIAGNOSIS DEVICE AND SENSOR FAILURE DIAGNOSIS METHOD

(75) Inventors: Hiroshi Tani, Kawasaki (JP); Yoshinari Higashino, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/393,545

(22) Filed: Feb. 26, 2009

(30) Foreign Application Priority Data
Feb. 28, 2008 (JP) 2008-48591

(51) Int. Cl. G01H 1/00

(52) U.S. Cl. 73/660

(57) ABSTRACT

A sensor failure diagnosis device including a control section that generates vibrations by moving a movable component inside a device is provided. The device includes a determining section that determines whether a value related to a vibration amount output from the sensor, which detects the vibrations generated in the device by the control section, falls within a predetermined range and an output section that outputs a result determined by the determining section.

### CROSS-REFERENCE TO RELATED APPLICATION

This application is related to and claims priority to Japanese Patent Application No. 2008-48591 filed on Feb. 28, 2008, and incorporated by reference herein.

### BACKGROUND

1. Field

The embodiments discussed herein are directed to a failure diagnosis of a sensor.

2. Description of the Related Art

The shock sensor and the acceleration sensor detect vibrations and impacts of a device, which are generated due to various causes, to avoid damages of peripheral parts.

It is, therefore, important in the device that the shock sensor and the acceleration sensor operate normally. This requires failure diagnosis to be performed on the shock sensor and the acceleration sensor with high accuracy.

Conventionally, in a technique for failure diagnosis of an acceleration sensor, the acceleration sensor can perform the failure diagnosis thereof by including an electrode dedicated for the failure diagnosis, applying an AC voltage to the electrode to generate vibrations in a pseudo way, and detecting accelerations generated by the vibrations (.

To perform failure diagnosis of a sensor such as a shock sensor or an acceleration sensor, however, vibrations and impacts need to be applied to the device in consideration of various causes possibly generating actual vibrations and impacts. For that reason, the sensor in the device has a difficulty in performing the failure diagnosis with high accuracy.

With the technique, the acceleration sensor can perform the failure diagnosis of itself by generating vibrations inside the acceleration sensor. However, because the vibrations are generated in a pseudo way inside the acceleration sensor, the failure diagnosis cannot be performed with high accuracy in consideration of actual vibrations and impacts generated by various causes. Further, because the acceleration sensor is needed to include an additional circuit, the cost is increased.

### SUMMARY

It is an aspect of an embodiment discussed herein to provide a sensor failure diagnosis device including a control section that generates vibrations by moving a movable component inside a device, a determining section that determines whether a value related to a vibration amount output from the sensor, which detects the vibrations generated in the device by the control section, falls within a predetermined range and an output section that outputs a result determined by the determining section.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 illustrates a magnetic disk device according to an embodiment;

FIG. 2 illustrates an exemplary layout of sensor installed positions according to an embodiment;

FIG. 3 illustrates a sensor failure diagnosis unit according to an embodiment;

FIG. 4 illustrates processing executed in the sensor failure diagnosis unit according to an embodiment;

FIG. 5A illustrates a sensor failure diagnosis process when a head-mounted actuator is hit against an inner stopper to generate vibrations;

FIG. 5B illustrates a sensor failure diagnosis process when vibrations are generated by starting rotation of a spindle motor;

FIG. 5C illustrates a sensor failure diagnosis process when vibrations are generated with a reciprocating seek (operation) of a magnetic head;

FIG. 6 illustrates an offset calculation process;

FIGS. 7A-7C illustrate exemplary plots indicating sensor outputs;

FIG. 8 illustrates a process for calculating an added-up value of a sensor output;

FIGS. 9A-9C illustrate exemplary plots indicating added-up values of sensor outputs;

FIGS. 10A-10C illustrate exemplary plots indicating added-up values of sensor outputs after filtering;

FIG. 11 illustrates an added-up value calculation process for the product (A×B) of sensor outputs of RV sensors A and B;

FIGS. 12A-12C illustrate exemplary plots each indicating a value resulting from adding up the product (A×B) of the sensor outputs of the RV sensors A and B;

FIG. 13 illustrates a process for calculating a ratio between the sensor outputs of the RV sensors A and B;

FIG. 14 illustrates a test process when failure diagnosis is performed in a test operation among operations of manufacturing the magnetic disk device;

FIG. 15 illustrates a failure diagnosis process executed at startup of the magnetic disk device;

FIG. 16 illustrates a failure diagnosis process executed at a retry of write and read of data; and

FIG. 17 illustrates a failure diagnosis process executed when a state waiting for a command issued from a host continues over a specified time.

### DETAILED DESCRIPTION THE PREFERRED EMBODIMENTS

Exemplary embodiments of a sensor failure diagnosis device, a recording device, a sensor failure diagnosis method, and an information storage system are discussed with reference to the drawings.

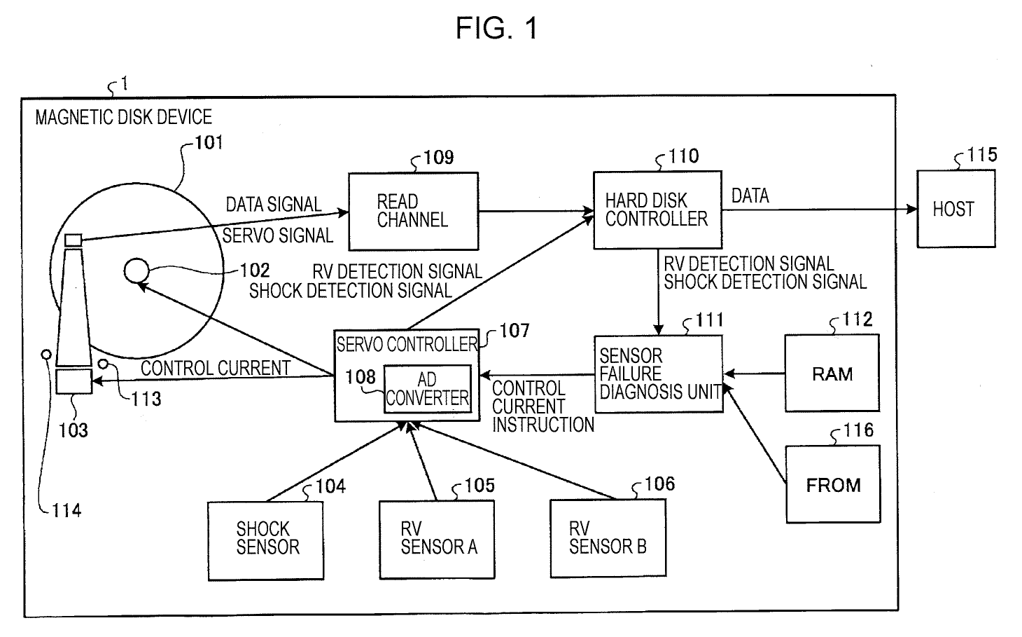

FIG. 1 illustrates a magnetic disk device according to an embodiment. As illustrated in FIG. 1, a magnetic disk device 1 includes a recording medium 101, a head-mounted actuator 103, a shock sensor 104, an RV (Rotary Vibration) sensor A 105, an RV sensor B 106, a servo controller 107, a read channel 109, a hard disk controller 110, a sensor failure diagnosis unit 111, a RAM (Random Access Memory) 112, an FROM 116 (nonvolatile memory), an inner stopper 113, and an outer stopper 114. The magnetic disk device 1 is connected to a host 115, i.e., a higher-level apparatus.

The recording medium 101 is a medium that magnetically records data. The spindle motor 102 rotates the recording medium 101, for example, in accordance with a control current output from the servo controller 107.

The head-mounted actuator 103 causes a magnetic head to move (seek) in the radial direction of the recording medium 101 in accordance, for example, with a control current output from the servo controller 107 to read magnetic data recorded on the recording medium 101. The head-mounted actuator 103 reads servo information in addition to the magnetic data. Further, the head-mounted actuator 103 outputs the read magnetic data as a data signal and the read servo information as a servo signal to the read channel 109.

The shock sensor 104 is a sensor for detecting vibrations applied to the magnetic disk device 1. The shock sensor 104 measures an amount of the detected vibration and outputs the measured vibration amount to the servo controller 107.

The RV sensor A 105 and the RV sensor B 106 detect vibrations corresponding, for example, to the circumferential direction of the recording medium 101. Each RV sensor measures an amount of the detected vibration and outputs the measured vibration amount to the servo controller 107. Sensor failure diagnosis performed in the magnetic disk device according to an embodiment is made on the shock sensor 104, the RV sensor A 105, and the RV sensor B 106, which are diagnosis targets.

The servo controller 107 controls the spindle motor 102 and the head-mounted actuator 103. For example, the servo controller 107 obtains, from the sensor failure diagnosis unit 111, a control current instruction representing an instruction to generate vibrations applied to the recording medium 101 (hereinafter also referred to as a “vibration generation instruction”) and controls the head-mounted actuator 103 or the spindle motor 102 in accordance with the control current instruction.

The servo controller 107 includes an AD converter 108 for converting vibration amounts output from the shock sensor 104, the RV sensor A 105, and the RV sensor B 106, which have detected vibrations, to digital signals from analog signals. Further, the servo controller 107 outputs, to the hard disk controller 110, a shock detection signal output from the shock sensor 104 and respective RV detection signals output from the RV sensor A 105 and the RV sensor B 106.

The read channel 109 obtains and demodulates the data signal and the servo signal both output from the head-mounted actuator 103 and outputs data resulting from the demodulation to the hard disk controller 110.

The hard disk controller 110 serves as a processing unit to control data write onto the recording medium 101 and data read from the recording medium 101. The hard disk controller 110 executes, for example, a process of transmitting the data resulting from the demodulation of the data signal to the host 115, i.e., the higher-level apparatus. Further, the hard disk controller 110 obtains the RV detection signals and the shock detection signal output, which are output from the servo controller 107, and outputs those signals to the sensor failure diagnosis unit 111.

The sensor failure diagnosis unit 111 diagnoses failures of the shock sensor 104, the RV sensor A 105, and the RV sensor B 106 installed to detect vibrations. The failure diagnosis can be performed, for example, when power supply to the magnetic disk device 1 is turned on, when a command instructing the sensor failure diagnosis is received from the host 115 in, e.g., a test operation of the magnetic disk device 1, when abnormality in data read or write has occurred, and when a time waiting for a command issued from the host 115 has exceeded a specified time.

In the failure diagnosis, the sensor failure diagnosis unit 111 first outputs the control current instruction, which represents the vibration generation instruction, to the servo controller 107. In accordance with the control current instruction, the servo controller 107 rotates the spindle motor 102, which has been in a stopped state, to generate vibrations by hitting the head-mounted actuator 103 against the inner stopper 113 or the outer stopper 114, or by causing the magnetic head to seek reciprocally.

Upon vibrations being generated as described above, the shock sensor 104, the RV sensor A 105, and the RV sensor B 106 detect the generated vibrations. Further, the shock sensor 104 outputs the shock detection signal containing information regarding an amount of the detected vibration, and the RV sensor A 105 and the RV sensor B 106 output the RV detection signals each representing an amount of the detected vibration. The sensor failure diagnosis unit 111 obtains the shock detection signal and the RV detection signals.

The failure diagnosis of the shock sensor 104, the RV sensor A 105, and the RV sensor B 106 is performed by processing the detected vibration amount in a predetermined manner to obtain a measurement value, and by comparing the measurement value with a preset reference value.

The sensor failure diagnosis unit 111 can read information regarding a previously specified allowable range of the measurement value (i.e., a specified range) from the FROM 116 and determines whether the measurement value is within the specified range. In other words, the specified range defines a range within which the measurement value falls when the sensor is normal. The specified range can be studied in advance by experiments, for example, and the resulting information is stored in the FROM 116.

If the measurement value falls within the specified range, the sensor failure diagnosis unit 111 determines that the sensor is normal, and outputs the determination result. If the measurement value does not fall within the specified range, the sensor failure diagnosis unit 111 determines that the sensor is abnormal, and outputs the determination result. Instead of performing the failure diagnosis after processing the detected vibration amount in the predetermined manner to obtain the measurement value, the failure diagnosis may also be performed by determining whether the vibration amounts obtained with the shock sensor 104, the RV sensor A 105, and the RV sensor B 106 and not subjected to the processing are each within a predetermined allowable range.

The RAM 112 is a Random Access Memory connected to the sensor failure diagnosis unit 111 and temporarily storing data. The FROM 116 stores an upper limit value and a lower limit value of the specified range, i.e., the allowable range of the measurement value.

The inner stopper 113 limits movement of the head-mounted actuator 103 in the direction toward an inner periphery of the recording medium 101. The outer stopper 114 limits movement of the head-mounted actuator 103 in the direction toward an outer periphery of the recording medium 101.

The host 115 serves as an upper-level apparatus for the magnetic disk device 1. For example, the host 115 issues predetermined commands to execute read of predetermined data from the recording medium 101 and write of predetermined data onto the recording medium 101.

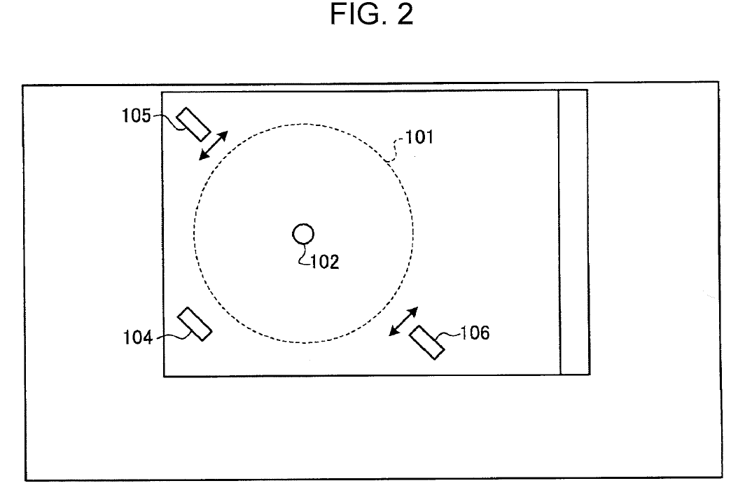

Sensor installed positions according to an embodiment will be described below with reference to FIG. 2. FIG. 2 illustrates one example of layout of the sensor installed positions according to an embodiment. As illustrated in FIG. 2, the shock sensor 104, the RV sensor A 105, and the RV sensor B 106 can be arranged near the outer periphery of the recording medium 101.

Further, the RV sensor A 105 and the RV sensor B 106 can be arranged on a diagonal line with the spindle motor 102 for the recording medium 101 located between both the sensors. Therefore, when the RV sensor A 105 and the RV sensor B 106 detect vibrations corresponding to the circumferential direction of the recording medium 101, the vibration amounts detected by the RV sensor A 105 and the RV sensor B 106 take values which are reversed in positive and negative signs, but which are substantially the same in absolute values. For example, when the vibration amount detected by the RV sensor A 105 is +100, the vibration amount detected by the RV sensor B 106 is about −100.

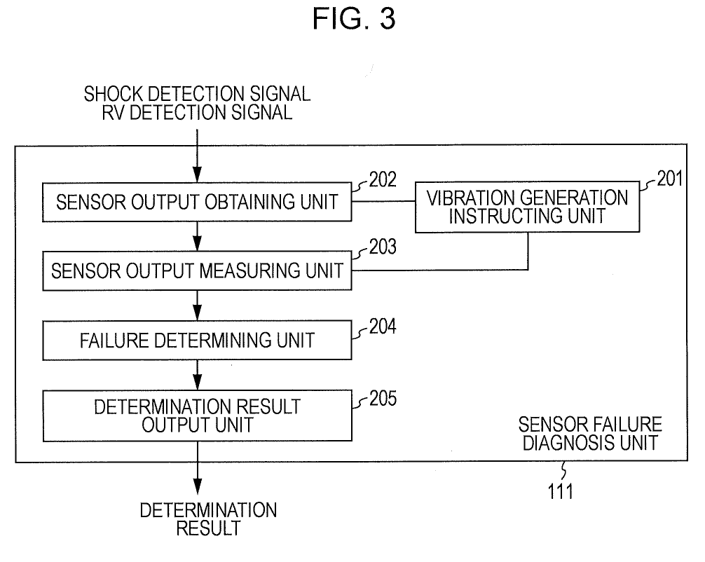

FIG. 3 illustrates a sensor failure diagnosis unit 111 according to an embodiment. As illustrated in FIG. 3, the sensor failure diagnosis unit 111 includes a vibration generation instructing unit 201, a sensor output obtaining unit 202, a sensor output measuring unit 203, a failure determining unit 204, and a determination result output unit 205.

The vibration generation instructing unit 201 outputs the control current instruction, which represents the vibration generation instruction, to the servo controller 107, for example, when a command to start the failure diagnosis is received from the host 115. Upon receiving the control current instruction, the servo controller 107 rotates the spindle motor 102, which has been in a stopped state, in accordance with the received control current instruction to generate vibrations in the magnetic disk device 1 by hitting the head-mounted actuator 103 against the inner stopper 113 or the outer stopper 114, or by causing the magnetic head to seek reciprocally.

The shock sensor 104, the RV sensor A 105, and the RV sensor B 106 detect the generated vibrations and measure vibration amounts corresponding to the detected vibrations. Subsequently, the shock sensor 104 outputs the shock detection signal containing representing the measured vibration amount, and the RV sensor A 105 and the RV sensor B 106 output the RV detection signals each representing the measured vibration amount.

Thereafter, the servo controller 107 can output the shock detection signal and the RV detection signals to the hard disk controller 110. The hard disk controller 110 can output the shock detection signal and the RV detection signals to the sensor failure diagnosis unit 111.

The sensor output obtaining unit 202 obtains the shock detection signal and the RV detection signals, which are output from the hard disk controller 110.

The sensor output measuring unit 203 executes predetermined processing on the respective vibration amounts represented by the shock detection signal and the RV detection signals, thus calculating measurement values. Whether each of the calculated measurement values falls within the specified ranges is determined and determination as to a sensor failure can be made based on the determination result.

The failure determining unit 204 reads the information regarding the preset specified range from the FROM 116 and determines whether each of the measurement values calculated by the sensor output measuring unit 203 falls within the specified range.

If the measurement value falls within the specified range, the failure determining unit 204 determines that the sensor is normal. If the measurement value does not fall within the specified range, the failure determining unit 204 determines that the sensor is faulty.

The determination result output unit 205 can output the determination result made by the failure determining unit 204 to the hard disk controller 110. In other words, the determination result output unit 205 can output the determination result regarding whether each of the shock sensor 104, the RV sensor A 105, and the RV sensor B 106 is normal or faulty.

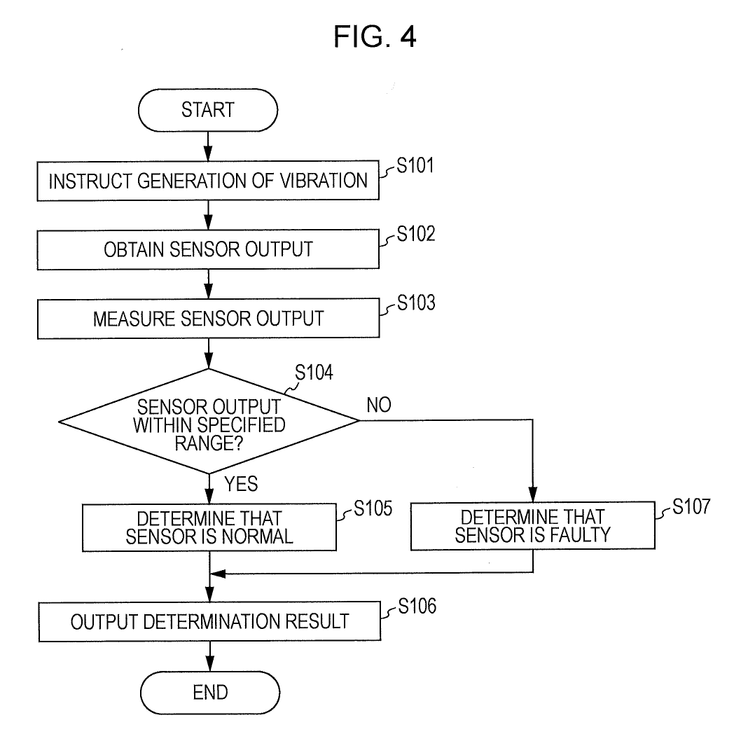

FIG. 4 illustrates processing executed in the sensor failure diagnosis unit 111 according to an embodiment.

The vibration generation instructing unit 201 in the sensor failure diagnosis unit 111 can output, to the servo controller 107, the vibration generation instruction for generating vibrations (S101). Then, the sensor output obtaining unit 202 obtains the RV detection signals and the shock detection signal output from the hard disk controller 110 (S102).

The sensor output measuring unit 203 calculates a measurement value from each of the vibration amounts represented by the RV detection signals and the shock detection signal (S1 03), which have been obtained by the sensor output obtaining unit 202. Then, the failure determining unit 204 reads the information of the specified range, which is stored in the FROM 116, and determines whether the measurement value falls within the specified range (S104).

If the measurement value falls within the specified range (Yes in S104), the failure determining unit 204 determines that the sensor is normal (S105), and can output the determination result (S106). On the other hand, if the measurement value does not fall within the specified range (No in S104), the failure determining unit 204 determines that the sensor is faulty (S107), and can output the determination result to the hard disk controller 110 (S106).

When the determination result output unit 205 can output the determination result that the shock sensor 104 is abnormal, the hard disk controller 110 may, for example, no longer accept any subsequent read and write commands, or may perform read and write after setting an off-track threshold to a stricter value (i.e., after setting an allowable shift value from the track center to be smaller than the currently set value).

When the determination result output unit 205 outputs the determination result that the RV sensor A 105 or the RV sensor B 106 is abnormal, the use of the sensor having been determined to be abnormal may be stopped, for example.

Thus, the failure diagnosis can be performed with high accuracy by using the sensor failure diagnosis unit 111 which rotates the spindle motor 102 having been in a stopped state to generate vibrations by hitting the head-mounted actuator 103 against the inner stopper 113 or the outer stopper 114, or by causing the magnetic head to seek reciprocally, and which determines a sensor failure depending on whether a value related to the amount of the vibration detected by each of the shock sensor 104, the RV sensor A 105, and the RV sensor B 106 (i.e., a measurement value) falls within the predetermined range (specified range).

Stated another way, because the sensor failure diagnosis unit 111 generates vibrations by moving a movable component in the magnetic disk device 1 and performs the failure diagnosis based on the generated vibrations, the failure diagnosis can be performed with high accuracy in consideration of actually possible vibrations without needing any modifications of a sensor unlike the known technique that the sensor is caused to generate vibrations in a pseudo way. Further, since vibrations can be generated inside the magnetic disk device 1 without applying the vibrations from the exterior, the failure diagnosis of the shock sensor 104, the RV sensor A 105, and the RV sensor B 106 can be easily performed without taking labor and time. In particular, the failure diagnosis after delivery of the magnetic disk device can be easily performed.

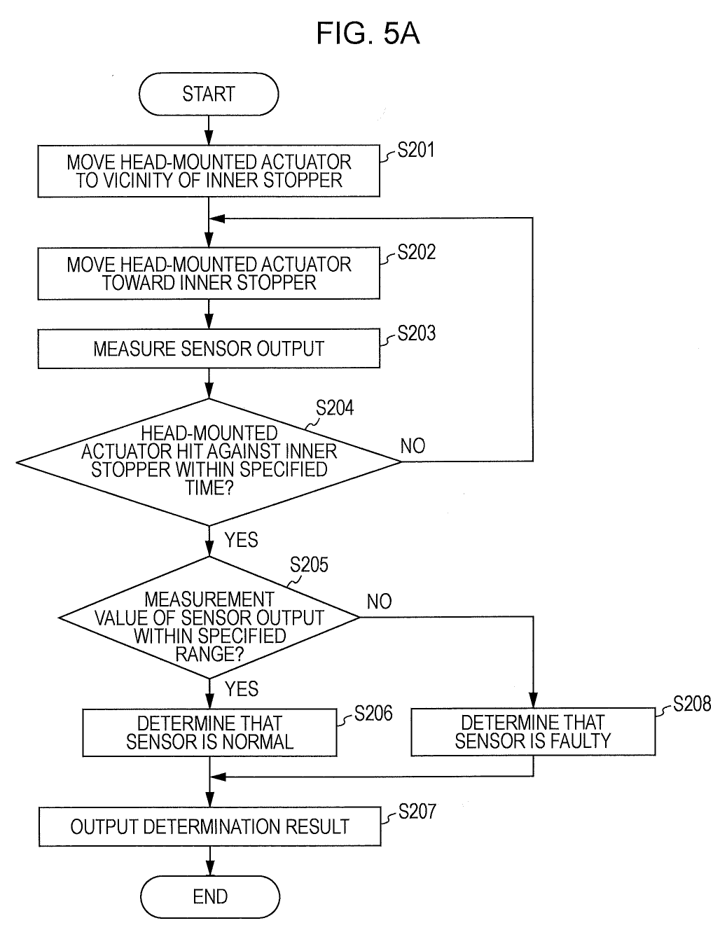

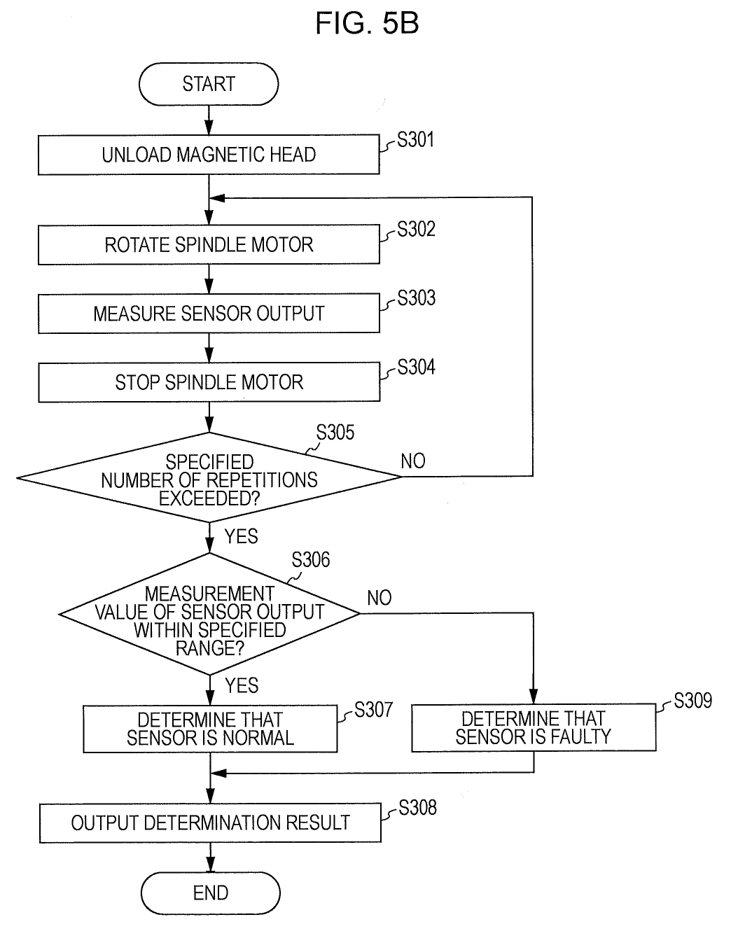

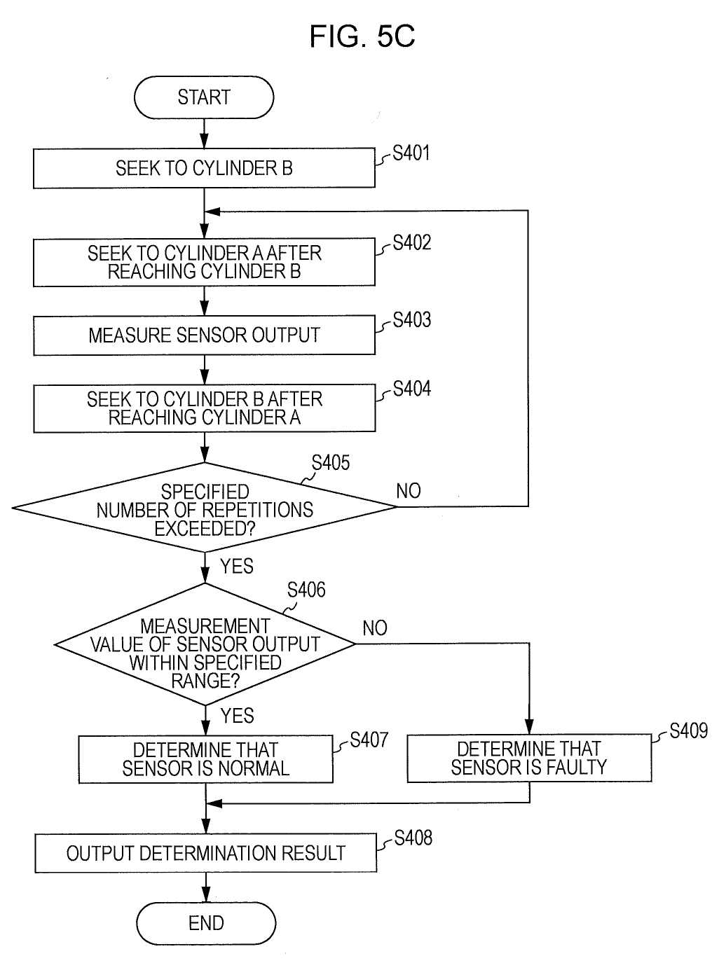

A process of generating vibrations in various methods by the vibration generation instructing unit 201 in the sensor failure diagnosis unit 111 according to this embodiment and performing the sensor failure diagnosis will be described below with reference to FIGS. 5A, 5B and 5C.

FIG. 5A illustrates a sensor failure diagnosis process when the head-mounted actuator 103 is hit against the inner stopper 113 to generate vibrations. Note that while the following description is made in connection with a case of hitting the head-mounted actuator 103 against the inner stopper 113, the vibrations may be generated by hitting the head-mounted actuator 103 against the outer stopper 114, for example.

When the vibration generation instructing unit 201 outputs the vibration generation instruction, which instructs hitting of the head-mounted actuator 103 against the inner stopper 113, to the servo controller 107, the servo controller 107 outputs a control current to the head-mounted actuator 103 in accordance with the vibration generation instruction, and the head-mounted actuator 103 is moved to the vicinity of the inner stopper 113 in response to the control signal (S201).

The servo controller 107 controls the head-mounted actuator 103 to continuously move toward the inner stopper 113, thus causing the head-mounted actuator 103 to hit against the inner stopper 113 (S202). As a result, vibrations are generated in the magnetic disk device 1.

The sensor output obtaining unit 202 obtains the shock detection signal and the RV detection signals output from the shock sensor 104, the RV sensor A 105, and the RV sensor B 106, which have detected the generated vibrations, and the sensor output measuring unit 203 calculates respective measurement values by executing the predetermined processing on information of vibration amounts which are contained in those detection signals (S203).

Thereafter, the vibration generation instructing unit 201 checks whether the head-mounted actuator 103 has been hit against the inner stopper 113 within a specified time (S204). Whether the head-mounted actuator 103 has been hit against the inner stopper 113 is determined, for example, by checking whether the information regarding any of the vibration amounts output from the shock sensor 104, the RV sensor A 105, and the RV sensor B 106 provides a value in excess of the predetermined value.

If the head-mounted actuator 103 has not been hit against the inner stopper 113 within the specified time (No in S204), the vibration generation instructing unit 201 outputs again the vibration generation instruction to the servo controller 107, and the servo controller 107 controls again the head-mounted actuator 103 to continuously move toward the inner stopper 113, thus causing the head-mounted actuator 103 to hit against the inner stopper 113 (S202).

If the head-mounted actuator 103 has been hit against the inner stopper 113 within the specified time (Yes in S204), the failure determining unit 204 checks whether the measurement value calculated based on the information of the vibration amount falls within the specified range (S205).

If the measurement value falls within the specified range (Yes in S205), the failure determining unit 204 determines that the sensor is normal (S206), and the determination result output unit 205 outputs the determination result to the hard disk controller 110 (S207).

If the measurement value does not fall within the specified range (No in S205), the failure determining unit 204 determines that the sensor is faulty (S208), and the determination result output unit 205 outputs the determination result to the hard disk controller 110 (S207).

FIG. 5B illustrates a sensor failure diagnosis process when vibrations are generated by starting rotation of the spindle motor 102.

When the vibration generation instructing unit 201 outputs, to the servo controller 107, an instruction for unloading the magnetic head, the servo controller 107 outputs a control current to the head-mounted actuator 103 in accordance with the instruction, thus causing the head-mounted actuator 103 to unload the magnetic head in response to the control signal (S301).

Subsequently, when the vibration generation instructing unit 201 outputs the vibration generation instruction, which instructs starting of rotation of the spindle motor 102, to the servo controller 107, the servo controller 107 starts the rotation of the spindle motor 102 (S302). As a result, vibrations are generated in the magnetic disk device 1.

The sensor output obtaining unit 202 obtains the shock detection signal and the RV detection signals output from the shock sensor 104, the RV sensor A 105, and the RV sensor B 106, which have detected the generated vibrations, and the sensor output measuring unit 203 calculates respective measurement values by executing the predetermined processing on information of vibration amounts which are contained in those detection signals (S303).

Thereafter, the vibration generation instructing unit 201 outputs an instruction for stopping the rotation of the spindle motor 102 to the servo controller 107, and the servo controller 107 stops the rotation of the spindle motor 102 (S304).

Further, the vibration generation instructing unit 201 checks whether repetitions of the process of rotating and stopping the spindle motor 102 has exceeded the specified number of repetitions (S305). If the specified number of repetitions is not exceeded (No in S305), the vibration generation instructing unit 201 outputs again the vibration generation instruction to the servo controller 107, and the servo controller 107 executes again the process of starting the rotation of the spindle motor 102 (S302).

If the specified number of repetitions is exceeded (Yes in S305), the failure determining unit 204 checks whether the measurement value calculated based on the information of the vibration amount falls within the specified range (S306).

If the measurement value falls within the specified range (Yes in S306), the failure determining unit 204 determines that the sensor is normal (S307), and the determination result output unit 205 outputs the determination result to the hard disk controller 110 (S308).

If the measurement value does not fall within the specified range (No in S306), the failure determining unit 204 determines that the sensor is faulty (S309), and the determination result output unit 205 outputs the determination result to the hard disk controller 110 (S308).

FIG. 5C illustrates a sensor failure diagnosis process when vibrations are generated with a reciprocating seek (operation) of the magnetic head.

When the vibration generation instructing unit 201 outputs, to the servo controller 107, an instruction for causing the magnetic head to seek to a cylinder B, the servo controller 107 outputs a control current to the head-mounted actuator 103 in accordance with the instruction, whereupon the head-mounted actuator 103 causes the magnetic head to seek to the cylinder B in response to the control signal (S401).

Subsequently, when the vibration generation instructing unit 201 outputs the vibration generation instruction, which instructs a seek of the magnetic head to a cylinder A, to the servo controller 107, the servo controller 107 controls the head-mounted actuator 103 such that the magnetic head seeks to the cylinder A after reaching the cylinder B (S402). As a result, vibrations are generated in the magnetic disk device 1.

The sensor output obtaining unit 202 obtains the shock detection signal and the RV detection signals output from the shock sensor 104, the RV sensor A 105, and the RV sensor B 106, which have detected the generated vibrations, and the sensor output measuring unit 203 calculates respective measurement values by executing the predetermined processing on information of vibration amounts which are contained in those detection signals (S403).

Thereafter, the vibration generation instructing unit 201 outputs, to the servo controller 107, an instruction for causing the magnetic head to seek to the cylinder B, and the servo controller 107 outputs a control current to the head-mounted actuator 103 in accordance with the instruction, whereupon the head-mounted actuator 103 causes the magnetic head to seek to the cylinder B in response to the control signal after reaching the cylinder A (S404).

Further, the vibration generation instructing unit 201 checks whether repetitions of the operation of moving the magnetic head from the cylinder B to the cylinder A and returning the magnetic head again to the cylinder B has exceeded the specified number of repetitions (S405). If the specified number of repetitions is not exceeded (No in S405), the vibration generation instructing unit 201 outputs again the vibration generation instruction to the servo controller 107, and the servo controller 107 executes again the process of causing the magnetic head to seek to the cylinder A (S402).

If the specified number of repetitions is exceeded (Yes in S405), the failure determining unit 204 checks whether the measurement value calculated based on the information of the vibration amount falls within the specified range (S406).

If the measurement value falls within the specified range (Yes in S406), the failure determining unit 204 determines that the sensor is normal (S407), and the determination result output unit 205 outputs the determination result to the hard disk controller 110 (S408).

If the measurement value does not fall within the specified range (No in S406), the failure determining unit 204 determines that the sensor is faulty (S409), and the determination result output unit 205 outputs the determination result to the hard disk controller 110 (S408).

Thus, the failure diagnosis of each sensor can be performed without taking labor and time because the sensor failure diagnosis unit 111 can perform the failure diagnosis by outputting the vibration generation instruction for generating vibrations in the magnetic disk device 1, to thereby generate the vibrations with the operation of the head-mounted actuator 103 or the spindle motor 102, and by detecting the generated vibrations with the shock sensor 104, the RV sensor A 105, and the RV sensor B 106. Further, the failure diagnosis in consideration of actually possible vibrations can be performed with high accuracy.

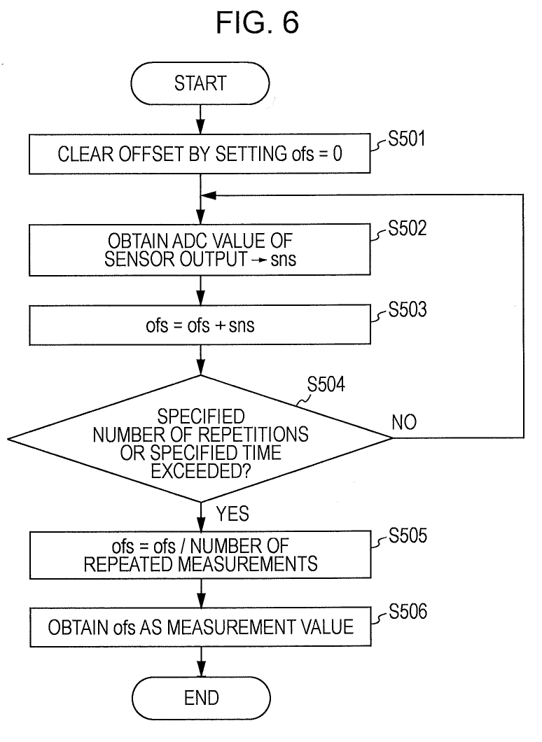

A method of calculating the measurement value by the sensor output measuring unit 203 in the sensor failure diagnosis unit 111 according to this embodiment will be described below with reference to FIGS. 6 to 13.

FIG. 6 illustrates an offset calculation process. Note that while the following description is made in connection with the case of executing offset calculation based on the vibration amount output from the shock sensor 104, the offset calculation is similarly executed based on the vibration amounts output from the RV sensor A 105 and the RV sensor B 106.

The sensor output measuring unit 203 sets an offset value (ofs) to 0, thus clearing the offset value (S501).

Then, the sensor output measuring unit 203 obtains an ADC value, which is obtained by the AD converter 108 converting the vibration amount output from the shock sensor 104 from an analog value to a digital value, and assigns the ADC value to a variable sns (S502).

Further, the sensor output measuring unit 203 adds the variable sns to the offset value (ofs), thus providing a new offset value (ofs) (S503).

Thereafter, the sensor output measuring unit 203 checks whether the number of the repeated processes of adding the ADC value to the offset value has exceeded the specified number of repetitions, or whether the processing time of adding the ADC value to the offset value has exceeded the specified time (S504). The reason of checking here whether the number of the repeated processes has exceeded the specified number of repetitions or whether the processing time has exceeded the specified time resides in controlling the number of samples of the ADC value used in the offset calculation.

If the number of the repeated processes has not yet exceeded the specified number of repetitions, or if the processing time has not yet exceeded the specified time (No in S504), the sensor output measuring unit 203 executes again the process of obtaining a new ADC value from the output of the shock sensor 104 and assigning the new ADC value to the variable sns (S502), followed by continuing the subsequent processing.

If the number of the repeated processes has exceeded the specified number of repetitions, or if the processing time has exceeded the specified time (Yes in S504), the sensor output measuring unit 203 divides the offset value by the number of repeated measurements, i.e., the number of the repeated processes of adding the ADC value to the offset value, to calculate an average value (S505) and sets the calculated result as the measurement value (S506). Then, whether the shock sensor 104 is faulty or not is determined, as described above, depending on whether the calculated measurement value falls within the specified range.

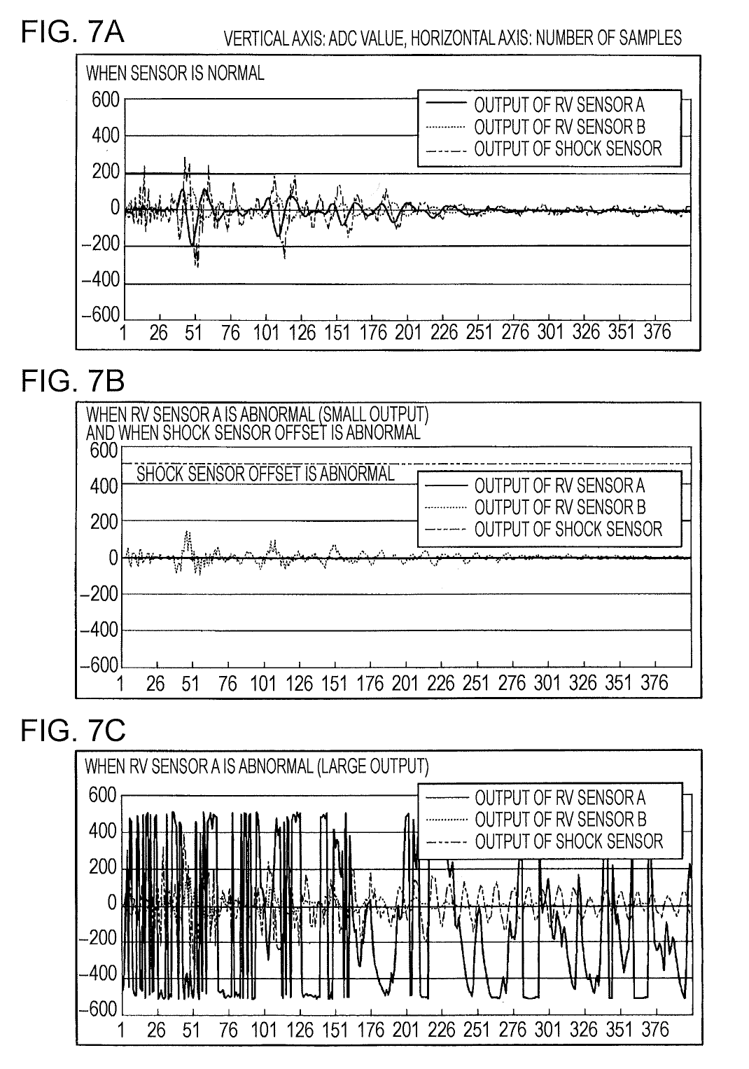

FIGS. 7A-7C illustrate exemplary plots indicating sensor outputs plotting the vibration amounts output from the shock sensor 104, the RV sensor A 105, and the RV sensor B 106 when vibrations are generated by hitting the head-mounted actuator 103 against the inner stopper 113.

FIG. 7A includes a plot representing the case that the shock sensor 104, the RV sensor A 105, and the RV sensor B 106 are all normal, FIG. 7B includes a plot representing the case that the vibration amount output from the RV sensor A 105 is so small as at an abnormal level and the vibration amount output from the shock sensor 104 is abnormal in offset, and FIG. 7C representing the case that the vibration amount output from the RV sensor A 105 is so large as at an abnormal level.

In each of the plots, the horizontal axis represents the number of samples, and the vertical axis represents the ADC value. Assuming here that samples are each sampled at constant intervals (e.g., about 20 ms (microseconds)), the number of samples can also be defined in terms of time.

In FIG. 7A, because the shock sensor 104, the RV sensor A 105, and the RV sensor B 106 are all normal, the calculated measurement value becomes a value close to zero when the offset calculation described above with reference to FIG. 6 is executed on the ADC value for each sensor.

On the other hand, in FIG. 7B where the shock sensor 104 is abnormal in offset, the offset calculation provides such a result that the calculated measurement value is much larger than the value in the normal state and is deviated from the specified range. Therefore, the abnormal state of the sensor can be easily and efficiently detected in the above-described situation.

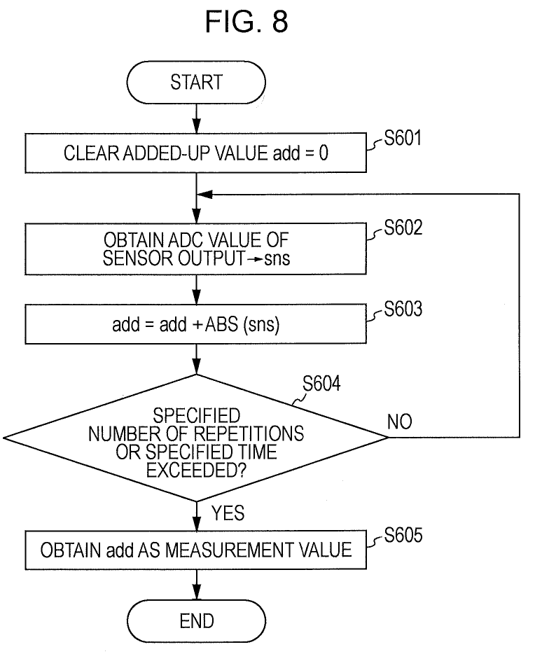

FIG. 8 illustrates a process for calculating an added-up value of a sensor output. Note that while the following description is made in connection with the case of calculating the added-up value based on the vibration amount output from the shock sensor 104, the calculation of the added-up value is similarly executed based on the vibration amounts output from the RV sensor A 105 and the RV sensor B 106.

The sensor output measuring unit 203 sets an added-up value (add) to 0, thus clearing the added-up value (S601).

Then, the sensor output measuring unit 203 obtains an ADC value, which is obtained by the AD converter 108 converting the vibration amount output from the shock sensor 104 from an analog value to a digital value, and assigns the ADC value to a variable sns (S602).

Further, the sensor output measuring unit 203 adds an absolute value of the variable sns to the added-up value (add), thus providing a new added-up value (add) (S603).

Thereafter, the sensor output measuring unit 203 checks whether the number of the repeated processes of adding the ADC value to the added-up value has exceeded the specified number of repetitions, or whether the processing time of adding the ADC value to the added-up value has exceeded the specified time (S604). The reason of checking here whether the number of the repeated processes has exceeded the specified number of repetitions or whether the processing time has exceeded the specified time resides in controlling the number of samples of the ADC value used in calculating the added-up value.

If the number of the repeated processes has not yet exceeded the specified number of repetitions, or if the processing time has not yet exceeded the specified time (No in S604), the sensor output measuring unit 203 executes again the process of obtaining a new ADC value from the output of the shock sensor 104 and assigning the new ADC value to the variable sns (S602), followed by continuing the subsequent processing.

If the number of the repeated processes has exceeded the specified number of repetitions, or if the processing time has exceeded the specified time (Yes in S604), the sensor output measuring unit 203 sets the added-up value as the measurement value (S605). Then, whether the shock sensor 104 is faulty or not is determined, as described above, depending on whether the thus-obtained measurement value falls within the specified range.

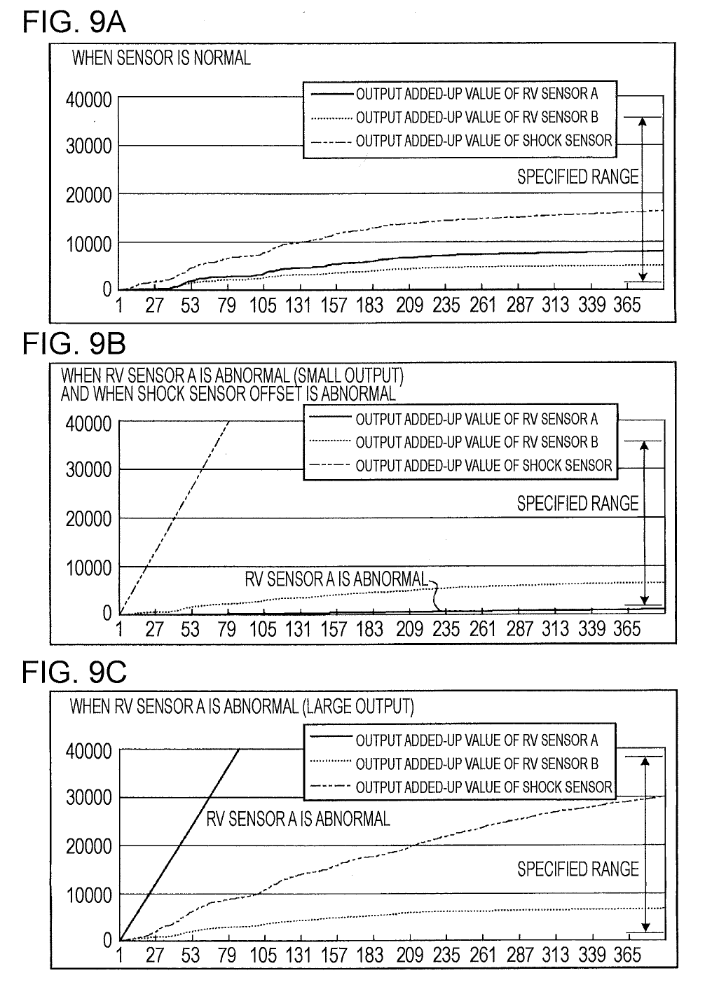

FIGS. 9A-9C illustrate exemplary plots indicating added-up values of sensor outputs of the added-up values calculated for the outputs from the shock sensor 104, the RV sensor A 105, and the RV sensor B 106 in accordance with the method, which has been described above with reference to FIG. 8, when vibrations are generated by hitting the head-mounted actuator 103 against the inner stopper 113. Sensor states, i.e., in what state (normal or abnormal state) each sensor is, in the FIGS. 9A-9C are the same as those in the FIGS. 7A-7C, and therefore a description of the sensor states is not repeated here.

In each of FIGS. 9A-9C, because the added-up value is calculated by successively adding an absolute value of the ADC value, the added-up value increases as the number of samples increases.

As illustrated in)FIG. 9A, when the shock sensor 104, the RV sensor A 105, and the RV sensor B 106 are all normal, the added-up value for each of the sensors is within the preset specified range. Accordingly, when the failure diagnosis is performed on the shock sensor 104, the RV sensor A 105, and the RV sensor B 106, each sensor is determined to be normal.

On the other hand, in FIG. 9B, because the value output from the RV sensor A 105 is abnormal (too small), the ADC values are all close to zero (see FIG. 7B and, upon the number of samples reaching the specified number, the added-up value does not fall within the preset specified range. Accordingly, the result of performing the failure diagnosis on the RV sensor A 105 is determined to be abnormal.

Also, in FIG. 9B, because the value output from the shock sensor 104 is abnormal in offset, the ADC values are all +500 (see FIG. 7B) and, upon the number of samples reaching the specified number, the added-up value does not fall within the preset specified range. Accordingly, the result of performing the failure diagnosis on the shock sensor 104 is determined to be abnormal.

Further, in FIG. 9C, because the vibration amount output from the RV sensor A 105 is abnormal (too large), the ADC value for each sample is extremely large (see the FIG. 7C and, upon the number of samples reaching the specified number, the added-up value does not fall within the preset specified range. Accordingly, the result of performing the failure diagnosis on the RV sensor A 105 is determined to be abnormal.

Thus, since the sensor failure diagnosis unit 111 determines a sensor failure based on the value resulting from adding up the absolute value of the ADC value output from each of the shock sensor 104, the RV sensor A 105, and the RV sensor B 106, a sensor failure can be easily and efficiently detected.

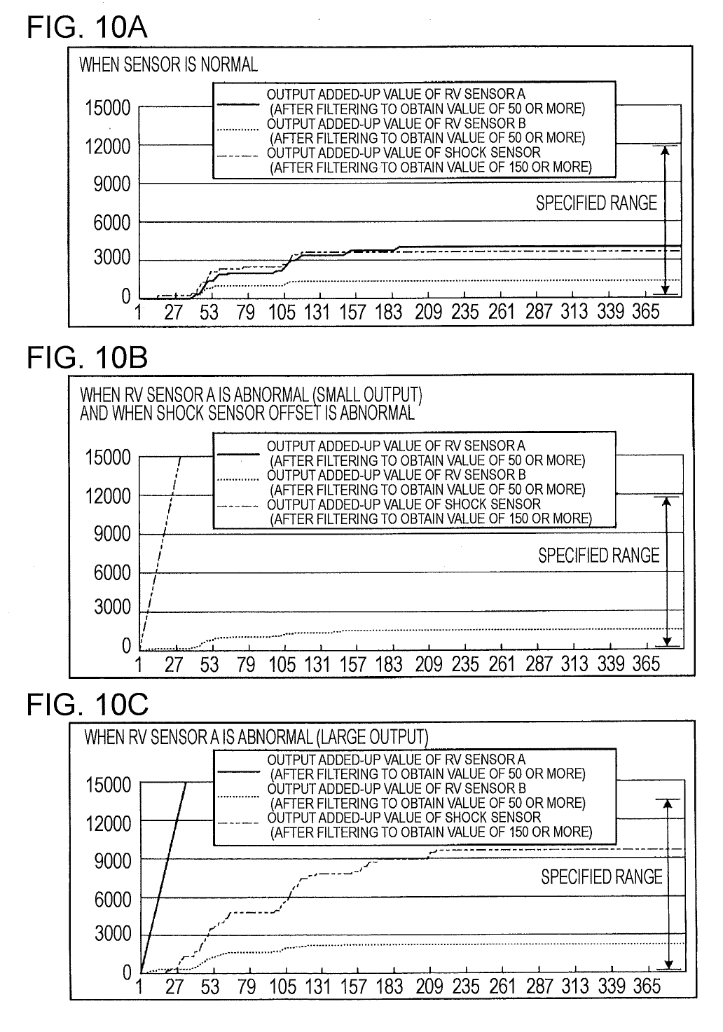

FIG. 10 illustrates examples of plots indicating added-up values of sensor outputs after filtering. FIG. 10 illustrates plots of the added-up values calculated for outputs, which are obtained after filtering the outputs from the shock sensor 104, the RV sensor A 105, and the RV sensor B 106, in accordance with the method described above with reference to FIG. 8, when vibrations are generated by hitting the head-mounted actuator 103 against the inner stopper 113.

The term “filtering” defines a process of cutting, as noise, an output value smaller than the specified value. In the examples of FIG. 10, to prevent the added-up values from being affected by noise, output values from the RV sensor A 105 and the RV sensor B 106 are set to 0 when the output values are smaller than 50, and an output value from the shock sensor 104 is set to 0 when the output value is smaller than 150. Sensor states, i.e., in what state (normal or abnormal state) each sensor is, in the plots FIGS. 10A-10C are the same as those in the plots (FIGS. 7A-7C, and therefore a description of the sensor states is not repeated here.

In each of the plots FIGS. 10A-10C, because the added-up value corresponding to individual samples is calculated after removing noise by filtering, the added-up value of the individual ADC values is provided free from noise. Thus, since the sensor failure diagnosis unit 111 can remove noise by calculating the added-up value after filtering the ADC values smaller than the specified value, diagnosis accuracy can be increased.

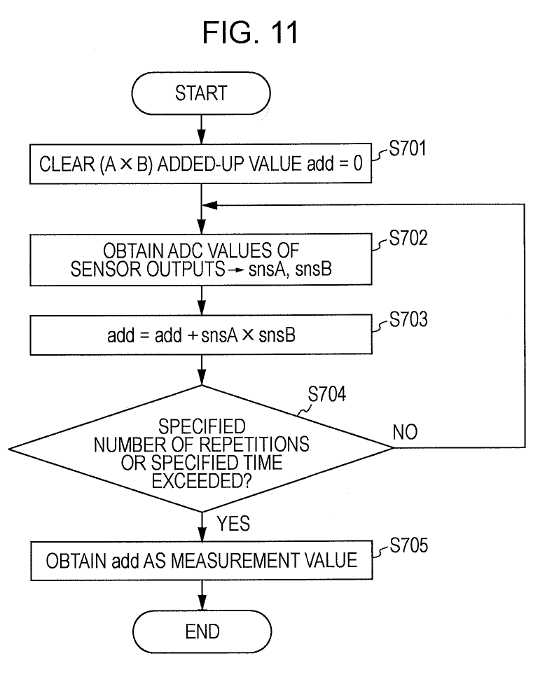

FIG. 11 illustrates an added-up value calculation process for the product (A×B) of sensor outputs of the RV sensor A 105 and the RV sensor B 106.

The sensor output measuring unit 203 sets an added-up value (add) to 0, thus clearing the added-up value (S701).

Then, the sensor output measuring unit 203 obtains ADC values, which are obtained by the AD converter 108 converting respective vibration amounts output from the RV sensor A 105 and the RV sensor B 106 from analog values to digital values, and assigns the ADC values to variable snsA and snsB (S702).

Further, the sensor output measuring unit 203 adds the product of the variable snsA and variable snsB to the added-up value (add), thus providing a new added-up value (add) (S703).

Thereafter, the sensor output measuring unit 203 checks whether the number of the repeated processes of adding the product to the added-up value has exceeded the specified number of repetitions, or whether the processing time of adding the product to the added-up value has exceeded the specified time (S704). The reason of checking here whether the number of the repeated processes has exceeded the specified number of repetitions or whether the processing time has exceeded the specified time resides in controlling the number of samples of the ADC value used in calculating the added-up value.

If the number of the repeated processes has not yet exceeded the specified number of repetitions, or if the processing time has not yet exceeded the specified time (No in S704), the sensor output measuring unit 203 executes again the process of obtaining new ADC values from the outputs of the RV sensor A 105 and the RV sensor B 106 and assigning the new ADC values to the variable snsA and the variable snsB (S702), followed by continuing the subsequent processing.

If the number of the repeated processes has exceeded the specified number of repetitions, or if the processing time has exceeded the specified time (Yes in S704), the sensor output measuring unit 203 sets the added-up value as the measurement value (S705). Then, whether the RV sensor A 105 and the RV sensor B 106 are faulty or not is determined, as described above, depending on whether the thus-obtained measurement value falls within the specified range.

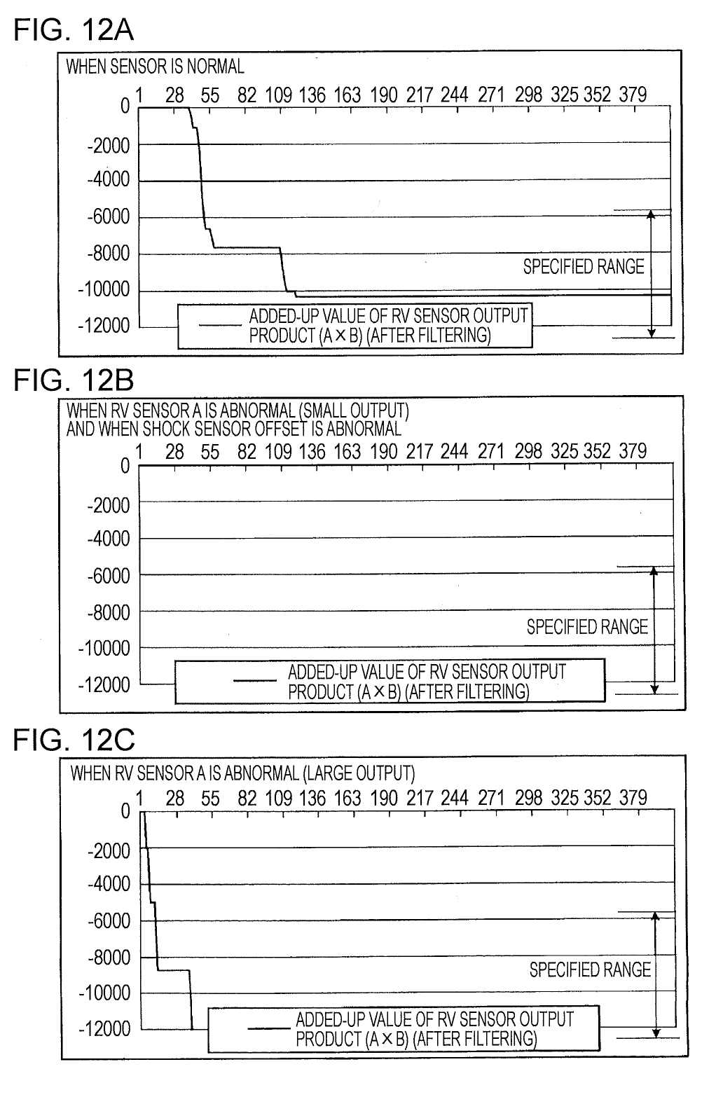

FIGS. 12A-12C illustrate exemplary plots each indicating a value resulting from adding up the product (A×B) of the sensor outputs of the RV sensor A 105 and the RV sensor B 106. Herein, FIGS. 12A-12C plot the added-up values calculated in accordance with the method, which has been described above with reference to FIG. 11, when vibrations are generated by hitting the head-mounted actuator 103 against the inner stopper 113.

Sensor states, i.e., in what state (normal or abnormal state) each sensor is, in FIGS. 12A-12C are the same as those in FIGS. 7A-7C, and therefore a description of the sensor states is not repeated here. Further, in FIGS. 12A-12C, the added-up value is calculated after filtering the output values of the RV sensor A 105 and the RV sensor B 106.

As illustrated in FIG. 12A, when the RV sensor A 105 and the RV sensor B 106 are both normal (FIG. 7A, the added-up value gradually decreases as the number of samples increases. Upon the number of samples reaching the specified number, the added-up value falls within the specified range. Accordingly, the result of performing the failure diagnosis on the RV sensor A 105 and the RV sensor B 106 is determined to be normal.

On the other hand, in FIG. 12B, because the vibration amount output from the RV sensor A 105 is abnormal (too small), the ADC values are all close to zero (see FIG. 7B and, upon the number of samples reaching the specified number, the added-up value does not fall within the specified range. Accordingly, the result of performing the failure diagnosis on the RV sensor A 105 and the RV sensor B 106 is determined to be abnormal.

Further, in FIG. 12C, because the vibration amount output from the RV sensor A 105 is abnormal (too large), the ADC value for each sample is extremely large (see FIG. 7C and, upon the number of samples reaching the specified number, the added-up value does not fall within the specified range. Accordingly, the result of performing the failure diagnosis on the RV sensor A 105 and the RV sensor B 106 is determined to be abnormal.

Thus, since the sensor failure diagnosis unit 111 adds up the product of the respective ADC values output from the RV sensor A 105 and the RV sensor B 106 and determines whether the added-up value falls within the specified range, the failure diagnosis can be easily and efficiently performed with high accuracy.

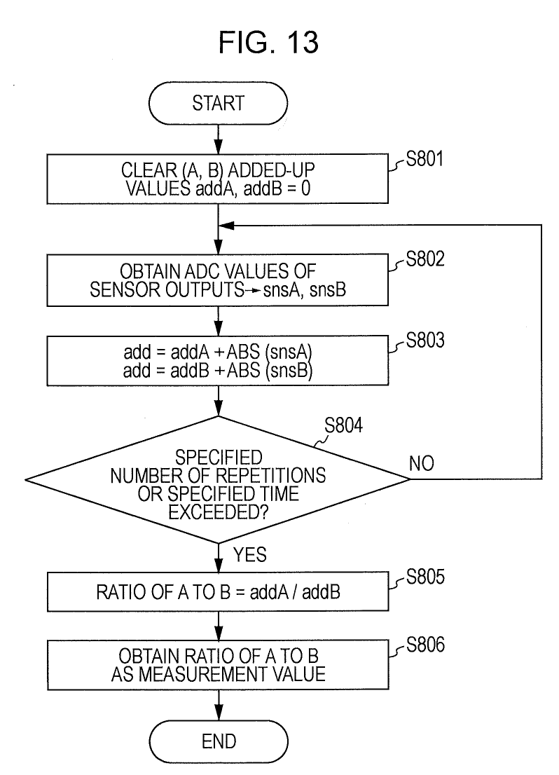

FIG. 13 illustrates a process for calculating a ratio between the sensor outputs of the RV sensor A 105 and the RV sensor B 106.

The sensor output measuring unit 203 sets added-up values (addA, addB) to 0, thus clearing the added-up values (S801).

Then, the sensor output measuring unit 2Q3 obtains ADC values, which are obtained by the AD converter 108 converting respective vibration amounts output from the RV sensor A 105 and the RV sensor B 106 from analog values to digital values, and assigns the ADC values to variable snsA and snsB (S802).

Further, the sensor output measuring unit 203 adds an absolute value of the variable snsA to the added-up value (addA), thus providing a new added-up value (addA), and also adds an absolute value of the variable snsB to the added-up value (addB), thus providing a new added-up value (addB) (S803).

Thereafter, the sensor output measuring unit 203 checks whether the number of the repeated processes of adding the absolute values to the added-up values has exceeded the specified number of repetitions, or whether the processing time of adding the absolute values to the added-up values has exceeded the specified time (S804). The reason of checking here whether the number of the repeated processes has exceeded the specified number of repetitions or whether the processing time has exceeded the specified time resides in controlling the number of samples of the ADC value used in calculating the added-up value.

If the number of the repeated processes has not yet exceeded the specified number of repetitions, or if the processing time has not yet exceeded the specified time (No in S804), the sensor output measuring unit 203 executes again the process of obtaining new ADC values from the outputs of the RV sensor A 105 and the RV sensor B 106 and assigning the new ADC values to the variable snsA and the variable snsB (S802), followed by continuing the subsequent processing.

If the number of the repeated processes has exceeded the specified number of repetitions, or if the processing time has exceeded the specified time (Yes in S804), the sensor output measuring unit 203 calculates a sensor output ratio (addA/addB) (S805) and sets the calculated ratio as the measurement value (S806). Then, whether the RV sensor A 105 and the RV sensor B 106 are faulty or not is determined, as described above, depending on whether the thus-obtained measurement value falls within the specified range.

Thus, since the sensor failure diagnosis unit 111 calculates added-up values of the respective ADC values output from the RV sensor A 105 and the RV sensor B 106 and further calculates a ratio between the added-up values, the failure diagnosis can be easily and efficiently performed with high accuracy.

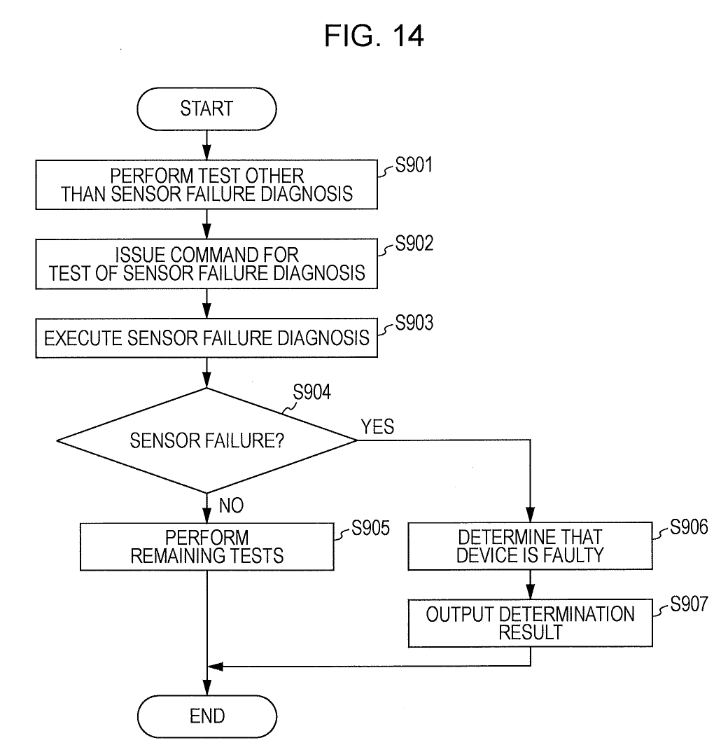

The timing of performing the failure diagnosis will be described below. FIG. 14 illustrates a test process when the failure diagnosis is performed in a test operation among operations of manufacturing the magnetic disk device 1.

A test device for the magnetic disk device 1 performs a test of the magnetic disk device 1 other than the sensor failure diagnosis (S901). Then, the test device issues, to the magnetic disk device 1, a command instructing the sensor failure diagnosis to be tested (S902). Upon receiving the command, the magnetic disk device 1 executes the sensor failure diagnosis process in accordance with the method described above (S903).

Thereafter, the test device receives information of the diagnosis result from the magnetic disk device 1 and checks whether the sensor is faulty (S904). If the sensor is not faulty (No in S904), the test device performs the remaining tests (S905) and then brings the test operation to an end. If the sensor is faulty (Yes in S904), the test device determines that the magnetic disk device is faulty (S906). Then, the test device outputs the determination result (S907) and brings the test operation to an end.

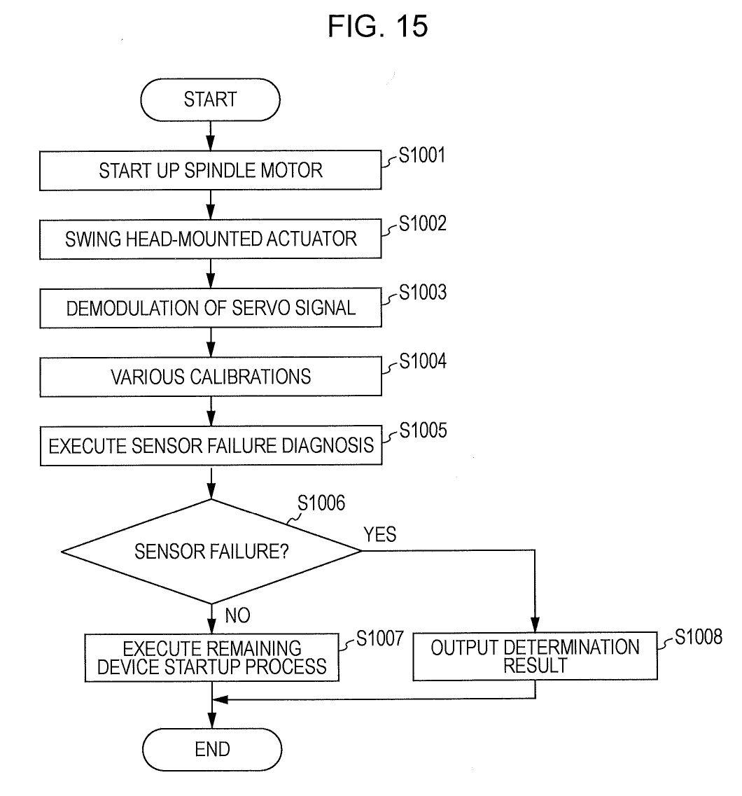

FIG. 15 illustrates a failure diagnosis process executed at startup of the magnetic disk device 1. First, upon power being turned on, the servo controller 107 starts up the spindle motor 102 (S1001) and swings the head-mounted actuator 103 (S1002).

Then, the read channel 109 executes a demodulation process for a servo signal read by the magnetic head on the head-mounted actuator 103 (S1003), and the hard disk controller 110 executes various calibrations upon receiving the result of the demodulation process (S1004).

Thereafter, the sensor failure diagnosis unit 111 executes the above-described sensor failure diagnosis (S1005). The hard disk controller 110 checks whether a sensor failure has been determined as a result of the failure diagnosis (S1006).

If the sensor failure has not been determined (No in S1006), the hard disk controller 110 executes the remaining startup process for the magnetic disk device 1 (S1007). If the sensor failure has been determined (Yes in S1006), the hard disk controller 110 outputs the determination result to the host 115, etc. (S1008).

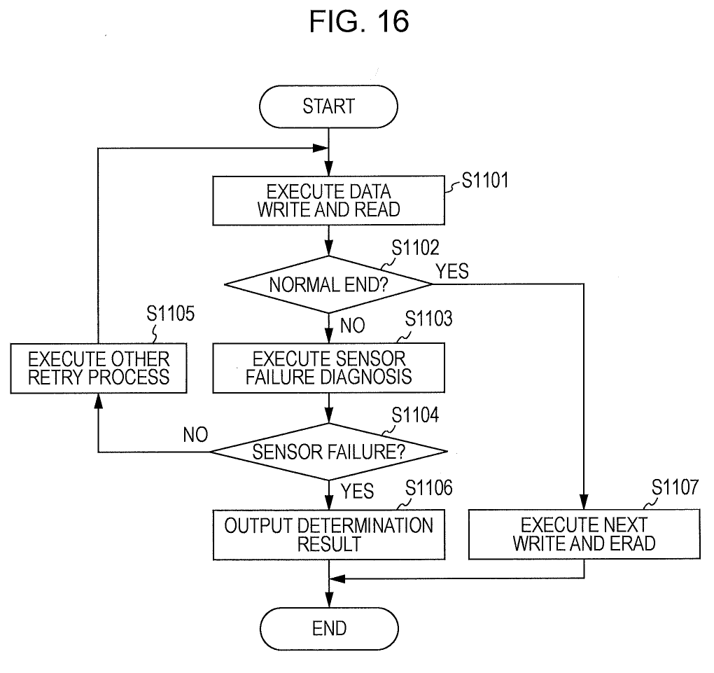

FIG. 16 illustrates a failure diagnosis process executed at a retry of write and read of data. The hard disk controller 110 executes a data read and write process (S1101) and checks whether the read and write process has normally ended (S1102). If the read and write process has normally ended (Yes in S1102), the hard disk controller 110 executes the next read and write process (S1107).

If the read and write process has not normally ended (No in S1102), the sensor failure diagnosis unit 111 executes the above-described sensor failure diagnosis (S1103). The hard disk controller 110 checks whether a sensor failure has been determined as a result of the failure diagnosis (S1104).

If the sensor failure has not been determined (No in S1104), the hard disk controller 110 executes the other retry process (S1105), thus executing again the data read and write process (S1101). If the sensor failure has been determined (Yes in S1104), the hard disk controller 110 outputs the determination result to the host 115, etc. (S1106).

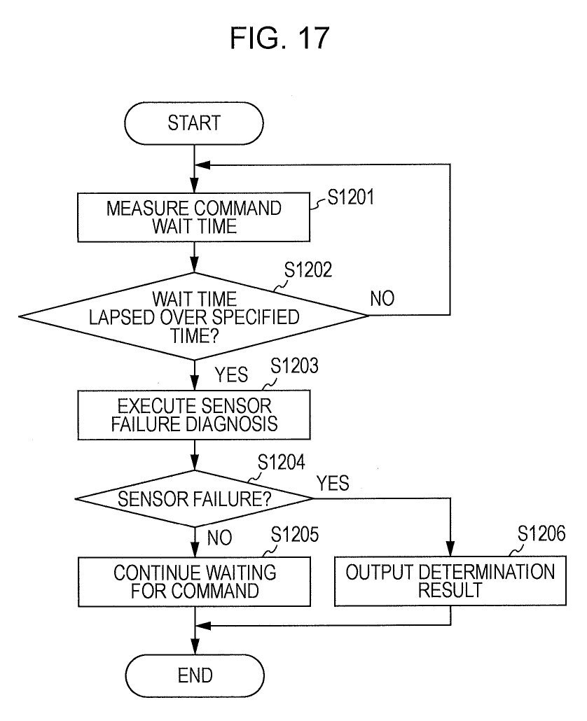

FIG. 17 illustrates a failure diagnosis process executed when a state waiting for a command issued from the host 115 continues over a specified time. The hard disk controller 110 measures a time during which a command waiting state continues (S1201) and checks whether the wait time has lapsed over the specified time (S1202).

If the wait time has not yet lapsed over the specified time (No in S1202), the hard disk controller 110 continues to measure the wait time (S1201). If the wait time has lapsed over the specified time (Yes in S1202), the sensor failure diagnosis unit 111 executes the above-described sensor failure diagnosis (S1203). The hard disk controller 110 checks whether a sensor failure has been determined as a result of the failure diagnosis (S1204).

If the sensor failure has not been determined (No in S1204), the hard disk controller 110 continues to wait a command (S1205). If the sensor failure has been determined (Yes in S1204), the hard disk controller 110 outputs the determination result to the host 115, etc. (S1206).

According to an embodiment, as described above, the sensor failure diagnosis unit 111 is disposed inside the magnetic disk device 1 and generates vibrations by moving a movable component (e.g., the spindle motor 102 or the head-mounted actuator 103) in the magnetic disk device 1. Further, a sensor (e.g., each of the shock sensor 104, the RV sensor A 105, and the RV sensor B 106) detects the vibrations generated in the magnetic disk device 1. The sensor failure diagnosis unit 111 determines whether a value related to a vibration amount output from the sensor (i.e., the measurement value) falls within the predetermined range (specified range), and outputs the determination result. Therefore, the failure diagnosis can be efficiently performed with high accuracy.

In other words, since the failure diagnosis is performed by causing the magnetic disk device 1 to generate actually possible vibrations and by detecting the generated vibrations with the sensor, highly-accurate failure diagnosis can be performed in consideration of the vibrations actually generated in the magnetic disk device 1 unlike conventional techniques where the sensor is caused to generate vibrations by itself in a pseudo way.

Moreover, since vibrations can be generated inside the magnetic disk device 1, the sensor failure diagnosis can be easily performed without taking labor and time. In particular, the failure diagnosis after delivery of the magnetic disk device can be easily performed.

The various processing functions executed in the magnetic disk device 1 may be realized, in the entirety or arbitrary part thereof, with a CPU (Central Processing Unit) (or a microcomputer such as an MPU (Micro Processing Unit) or an MCU (Micro Controller Unit)) and a program that is analyzed and executed by the CPU (or the MPU or the MCU), or with hardware in the form of wired logics. While an embodiment has been described as reading the specified range for the failure determination from the FROM 116 which is a nonvolatile memory, the specified range may be obtained by reading data written on a recording medium, or may be instructed from the host 115.

Various modified forms of an embodiment are disclosed in the attached claims. The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing an embodiments may be recorded on computer-readable media comprising computer-readable recording media. The program/software implementing an embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of an embodiments, any combinations of the described features, functions and/or operations can be provided.

The many features and advantages of an embodiments are apparent from the detailed specification and, thus, it is intended by the appended claims to cover all such features and advantages of an embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A sensor failure diagnosis device for diagnosing a failure of a sensor that detects vibrations of a device, the sensor failure diagnosis device comprising:
a control section disposed in the device and generating vibrations by moving a movable component inside the device;
a determining section for determining whether a value related to a vibration amount output from the sensor, which detects the vibrations generated in the recording device by the control section, falls within a predetermined range; and
an output section for outputting a result determined by the determining section.

2. The sensor failure diagnosis device according to claim 1, further comprising a measuring section for calculating the value related to the vibration amount by adding up the vibration amount output from the sensor, wherein the determining section determines whether the value calculated by the determining section falls within the predetermined range.

3. The sensor failure diagnosis device according to claim 2, wherein the measuring section calculates the value related to the vibration amount by adding up the vibration amount output from the sensor and calculating an average value of the added-up vibration amounts.

4. The sensor failure diagnosis device according to claim 2, wherein the measuring section calculates the value related to the vibration amount by adding up the product of vibration amounts output from plural sensors.

5. The sensor failure diagnosis device according to claim 2, wherein the measuring section calculates the value related to the vibration amount by adding up respective vibration amounts output from plural sensors and calculating a ratio between or among added-up values.

6. The sensor failure diagnosis device according to any one of claim 2, wherein the measuring section calculates the value related to the vibration amount after excluding those ones of the vibration amounts output from the one or plural sensors, which are smaller than a specified amount.

7. A recording device with a function of diagnosing a failure of a sensor that detects vibrations, the recording device comprising:
a control section disposed in the recording device and generating vibrations by moving a movable component inside the recording device;
the sensor detecting the vibrations generated in the recording device and outputting a vibration amount of the detected vibration;
a determining section for determining whether a value related to the vibration amount output from the sensor falls within a predetermined range; and
an output section for outputting a result determined by the determining section.

8. A sensor failure diagnosis method for diagnosing a failure of a sensor that detects vibrations of a device, the sensor failure diagnosis method comprising:
controlling executed in the device and generating vibrations by moving a movable component inside the device;
determining whether a value related to a vibration amount output from the sensor, which detects the vibrations generated in the device in the controlling, falls within a predetermined range; and
of outputting a result determined in the determining.

9. The sensor failure diagnosis method according to claim 8, further comprising a measuring of calculating the value related to the vibration amount by adding up the vibration amount output from the sensor,
wherein the determining determines whether the value calculated in the determining falls within the predetermined range.

10. The sensor failure diagnosis method according to claim 9, wherein the measuring calculates the value related to the vibration amount by adding up the vibration amount output from the sensor and calculating an average value of the added-up vibration amounts.

11. The sensor failure diagnosis method according to claim 9, wherein the measuring calculates the value related to the vibration amount by adding up the product of vibration amounts output from plural sensors.

12. The sensor failure diagnosis method according to claim 9, wherein the measuring calculates the value related to the vibration amount by adding up respective vibration amounts output from plural sensors and calculating a ratio between or among added-up values.

13. The sensor failure diagnosis method according to any one of claims 9, wherein the measuring calculates the value related to the vibration amount after excluding those ones of the vibration amounts output from the one or plural sensors, which is smaller than a specified amount.
